(19) United States
(12) Patent Application Publication
(10) Pub. No.: US 2008/0133675 A1
(43) Pub. Date: Jun. 5, 2008

(54) EMBEDDING RICH CONTENT IN REAL-TIME COMMUNICATIONS

(75) Inventors: Rajesh Ramanathan, Redmond, WA (US); Eran Shtiegman, Redmond, WA (US); Parag Samdadiya, Bellevue, WA (US); Marc Boyer, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/566,650

(22) Filed: Dec. 4, 2006

(51) Int. Cl. G06F 15/16; G06F 13/00

(52) U.S. Cl. 709/206; 719/328

(57) ABSTRACT

A real-time communication system receives rich application content from a user. The real-time communication system detects that the user wants to send a message containing the application content, and determines the application that produced the content. For example, if the content was pasted using the operating system clipboard, then the pasted content may contain information indicating the application that produced it. Then the real-time communication system creates a real-time communication containing the application content and identifying the application that produced the content. For example, the real-time communication may be structured as XML that contains the application content and an application identifier. Finally, the real-time communication system sends the real-time communication to the receiving participant.

### BACKGROUND

Users of computing devices (e.g., laptops, cellular phones, and personal digital assistants) often need to communicate in real time. A common form of real-time communications is provided by instant messaging services. An instant messaging service allows participants at endpoints to send messages and have them received within a second or two by the other participants in a conversation. The receiving participants can then send responsive messages to the other participants in a similar manner. To be effective, a real-time conversation relies on the participants' becoming aware of, reviewing, and responding to received messages very quickly. This quick response is in contrast to conventional electronic mail systems in which the recipients of electronic mail messages respond to messages at their convenience.

To support real-time communications, communications applications typically need to establish and manage connections (also referred to as sessions or dialogs) between computing devices. A session is a set of interactions between computing devices that occurs over a period of time. As an example, real-time communications applications such as MESSENGER or Voice over Internet Protocol (“VoIP”) establish sessions between communicating devices on behalf of users. These applications may use various mechanisms to establish sessions, such as a “Session Initiation Protocol” (“SIP”). SIP is an application-level control protocol that computing devices can use to discover one another and to establish, modify, and terminate sessions between computing devices. SIP is a proposed Internet standard. The SIP specification, “RFC 3261,” is available at <www.ietf.org/rfc/rfc3261.txt>.

Applications may employ SIP with a lower-level protocol to send or receive messages. SIP may use lower-level connections to transport a dialog's messages, such as Transmission Control Protocol/Internet Protocol (“TCP/IP”), which are commonly employed transport- and network-layer protocols. Transmission Control Protocol (“TCP”) is a connection-oriented, reliable-delivery transport-layer protocol. TCP is typically described as a transport layer that provides an interface between an application layer (e.g., an application using SIP) and a network layer. The application layer generally communicates with the TCP layer by sending or receiving a stream of data (e.g., a number of bytes of data). TCP organizes this data stream into segments that can be carried by the protocol employed at the network layer, e.g., the Internet Protocol (“IP”). These segments of data are commonly referred to as “packets,” “frames,” or “messages.” Each message generally comprises a header and a payload. The header comprises data necessary for routing and interpreting the message. The payload comprises the actual data that is being sent or received. The application, transport, and network layers, together with other layers, are jointly referred to as a data communications stack.

When an initiating participant wants to start a real-time conversation, that participant needs to know whether the intended participants are available to respond in real time to a message. If not, then communications via conventional electronic mail, voice mail, or some other mechanism may be more appropriate. For example, if the computers of the intended participants are currently powered off, then a real-time conversation may not be possible. Moreover, if their computers are currently powered on, but the intended participants are away from their computers, a real-time conversation is also not possible. The initiating participant would like to know the availability of the intended participants so that an appropriate decision on the form of communication can be made.

The availability status of an entity such as a computer system (i.e., endpoint) or a user associated with that computer system is referred to as “presence information.” Presence information identifies the current “presence state” of the user. Users make their presence information available so that other users can decide how best to communicate with them. For example, the presence information may indicate whether a user is logged on (“online”) with an instant messaging server or is logged off (“offline”). Presence information may also provide more detailed information about the availability of the user. For example, even though a user is online, that user may be away from their computer in a meeting. In such a case, the presence state may indicate “online” and “in a meeting.”

In an instant messaging context, a publishing user (“publisher”) may provide their presence information to a presence server that then provides the presence information to subscribing users (“subscribers”). Thus, a presence server may use a subscriber/publisher model to provide the presence information for the users of the presence service. Whenever the presence information of a user changes, the presence server is notified of the change by that user's computer system, and in turn, the presence server notifies the subscribing users of the change. A subscribing user can then decide whether to initiate an instant messaging conversation based on the presence information of the intended participants. For example, if the presence information indicates that a publishing user is currently in a conference telephone call, then the subscribing user may decide to send an instant message, rather than place a telephone call, to the publishing user. If the subscribing user, however, needs to call and speak with the publishing user, the subscribing user needs to monitor the presence information of the publishing user to know when the call can be placed. When the subscribing user notices that the publishing user's presence information indicates that the telephone conference has been concluded, the subscribing user can then place the telephone call. A specification relating to presence information in instant messaging systems, “RFC 2778,” is available at <www.ietf.org/rfc/rfc2778.txt>. A draft of a proposed specification relating to presence information in SIP is available at <www.ietf.org/internet-drafts/draft-ietf-simple-presence-10.txt>.

A sending participant often initiates a real-time conversation by selecting a receiving participant and indicating that they want to send the receiving participant an instant message. In some systems, this action causes the system to send a SIP INVITE message to the receiving participant, and to open a conversation window in a user interface displayed to the sending participant. When the receiving participant's endpoint receives the INVITE message, the receiving participant's endpoint also opens a conversation window in a user interface displayed to the receiving participant and replies to the INVITE message indicating that a connection for the conversation has been formed. The sending and receiving participants can then send messages back and forth over the new connection by typing messages in the conversation window.

Real-time communication participants often have many applications installed on the computing devices that they use for participating in instant messaging conversations. For example, desktop computers often contain a word processor, spreadsheet, presentation, and other content-producing applications. However, most real-time communications take place using plain text or sometimes text with simple icons embedded (e.g., emoticons). Real-time communication participants are unable to utilize the content-processing capabilities of the applications available on their computing devices to enhance real-time communication conversations. Some traditional systems allow participants to send files outside the context of a real-time conversation or to embed hyperlinks within the plain text of a message. However, the receiving participant is removed from the flow of the conversation when viewing such hyperlinks or opening such files, and may miss additional messages from the sending participant or have to manage multiple windows to follow the sending participant's intended purpose for sending the application content. For example, the participants may be participating in an online conference and sharing information such as a slide presentation, and it is difficult for the sending participant to coordinate activities such as focusing each participant on a particular slide of the presentation.

### SUMMARY

A method and system for embedding rich application content in real-time conversations is provided. A real-time communication system receives rich application content from a user. The real-time communication system detects that the user wants to send a message containing the application content, and determines the application that produced the content. Then, the real-time communication system creates a real-time communication containing the application content and identifying the application that produced the content. For example, the real-time communication may be structured using extensible Markup Language (“XML”) and contain both the application content and an application identifier. Finally, the real-time communication system sends the real-time communication to the receiving participant.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the real-time communication system, in one embodiment.

FIG. 2 is a flow diagram that illustrates the processing of the render embedded content component of the system, in one embodiment.

FIG. 3 is a flow diagram that illustrates the processing of the embed content component of the system, in one embodiment.

FIG. 4 is a flow diagram that illustrates the processing of the negotiate content capabilities component of the system, in one embodiment.

FIG. 5 illustrates a network packet containing an instant message with application content, in one embodiment.

FIG. 6 illustrates a conversation window of the user interface of the real-time communication system, in one embodiment.

### DETAILED DESCRIPTION

A method and system for embedding rich application content in real-time conversations is provided. The real-time communication system receives application content from a user. For example, the user may have an instant messaging conversation window open, and may paste content from a word processing application into the instant messaging conversation window using an operating system-provided clipboard for sharing content across applications. The real-time communication system detects that the user wants to send a message containing the application content, and determines the application that produced the content. For example, if the content was pasted using the operating system clipboard, then the pasted content may contain information indicating the application that produced it. Alternatively, the user may select the content by browsing for a file, and the file's extension may indicate the application that produced the content in the file. Then the real-time communication system creates a real-time communication containing the application content and identifying the application that produced the content. For example, the real-time communication may be structured as XML that contains the application content and an application identifier. Finally, the real-time communication system sends the real-time communication to the receiving participant. In this way, participants can exchange real-time communications that leverage the advanced content capabilities of other applications available to their computing devices.

In some embodiments, the real-time communication system renders application content directly in a real-time communication conversation window. For example, if the application content is word processing content containing formatted text, graphics, or other content, then upon receiving the application content, the real-time communication system invokes the application to render the application content in an existing conversation window. The application content then appears to be a cohesive part of the conversation to the conversation participants. The application may provide an ActiveX control or other embeddable control that renders the application content in a specified display region. For example, the real-time communication software may invoke such a control with the screen coordinates where the content should appear, and then depend on the control to render the application content within the specified region of the screen.

In some embodiments, the real-time communication system displays a preview of the content in a real-time communication conversation window. For example, the content may be complex or too large for a typical conversation window. Therefore, the real-time communication system may create a preview of the content that is displayable within the conversation window, and then offer to invoke an application for displaying the content externally from the conversation window. For example, the preview may contain a bitmap image representative of the content, and the conversation window may contain a hyperlink that, upon being clicked by a user, opens an application window containing a view of the application content.

In some embodiments, the real-time communication system facilitates archiving real-time conversations including application content. In traditional instant messaging systems, any content that is allowed to be sent is external to the conversation, either as a separate file or as a hyperlink to a file available from a network resource. However, the real-time communication system permits application content to be embedded directly within real-time communications. Many organizations save a conversation history of the conversations of which a participant has been a part, and allow the participant to view these conversations as messages within a folder of the participant's email inbox. When saving traditional real-time communications in this way, any content that is external to the conversation is lost. The real-time communication system captures application content directly within the communications that are part of the conversation, and therefore the content is available when a participant later attempts to review the archived conversation. The content may be embedded directly within an email message that the conversation is stored in, or it may be included as an attachment to the message for easy viewing by the participant.

In some embodiments, the real-time communication system negotiates application content capabilities between participants at the start of a conversation. For example, if the conversation is initiated using SIP, then the SIP INVITE message may contain the application content capabilities of the sending participant, and the SIP response may contain the application content capabilities of the receiving participant. The sending participant may send a list of all the content-producing applications installed on the sending participant's computing device, or some other identifier of the types of content that the sending participant's computing device can render. For example, the “Content-Type” or “Supported” tag of the SIP INVITE may contain a value “application-ms-ole-embedded” indicating that the sending participant supports Microsoft Object Linking and Embedding (“OLE”) application content. Likewise, the receiving participant may include a similar header that indicates the applications that the receiving participant's computing device supports. If the application content capabilities of the sending and receiving participants do not match, then the real-time communication system may prevent one participant from sending content that the other participant cannot display. Alternatively, the participant that lacks a particular application content capability may request that a participant desiring to send that type of content use an alternative application or convert the application content into a common format, such as Hypertext Markup Language (“HTML”). The real-time communication system may also send application content capabilities between participants along with any message of a conversation. For example, the system may send application content capabilities within a SIP MESSAGE message.

The real-time communication system allows participants to add application content to a real-time conversation in many ways. For example, as described above, the participants may use an operating system-provided clipboard to paste content from an application into a real-time conversation window. An application may also offer an option to send content in a real-time conversation. For example, a collaboration portal server, such as Microsoft SharePoint Server, can allow a user creating a form on a portal site to send the form to another logged-on user to review the form. As another example, two participants may be using a workflow application, such as Microsoft InfoPath, to review an expense report that needs to be approved, and may send portions of the expense report back and forth within a real-time conversation along with comments about each portion. Even though a real-time conversation between the two users does not already exist, the real-time communication system may create a conversation between the users and place the application content (e.g., the form or expense report) into the conversation as an initial message. Participants may also browse to a file or other content within a real-time communication client application and select the content for embedding within an on-going real-time conversation.

In some embodiments, when a participant adds application content to a real-time conversation, the real-time communication system adds supplemental information to the application content. For example, the real-time communication system may determine the application that created the content and embed an identifier identifying the application along with the content itself within a real-time communication message. The real-time communication system may also capture other information such as the version of the application and any templates, fonts, or other supplemental information that would be useful for rendering the application content at the receiving participant's computing device. When the receiving participant's computing device receives the message, the device opens the message, determines if it contains application content, and invokes the appropriate application for rendering the application content.

The real-time communication system may embed application content within a real-time conversation in many ways. For example, as described above, XML may be used to structure the different parts of a real-time communication, including a text message, application content, and any supplemental information. However, other methods may also be used. For example, OLE specifies a format for data to be shared between applications, and this format may be used to encapsulate data from one application to be included within an instant messaging conversation. As another example, Remote Procedure Call (“RPC”) may be used to package the application content in a binary format for transmission over a network and rendering at a location separate from the origin of the application content.

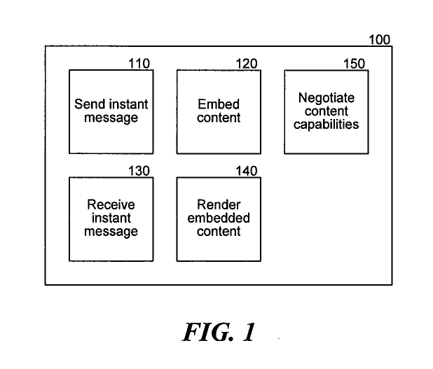

FIG. 1 is a block diagram that illustrates components of the real-time communication system, in one embodiment. The real-time communication system 100 contains a send instant message component 110, an embed content component 120, a receive instant message component 130, a render embedded content component 140, and a negotiate content capabilities component 150. The send instant message component 110 detects when a sending participant wants to send an instant message, and conveys the message through an existing connection to the receiving participant. The embed content component 120 works with the send instant message component 110 to detect any application content that the user wants to send with the instant message, and encapsulates the application content in an appropriate form for transmission to the receiving participant's endpoint. For example, the embed content component 120 may encapsulate the application content in an XML message that includes the content and an application identifier. The receive instant message component 130 receives real-time communications sent by a sending participant and displays the communications to the receiving participant. The render embedded content component 140 works with the receive instant message component 130 to render any application content included in received real-time communications. For example, the render embedded content component 140 may invoke an application that produced the content to render the content within an instant messaging conversation window. The negotiate content capabilities component 150 determines the capabilities of two connected endpoints so that application content can be shared using applications available to each of the endpoints. For example, the negotiate content capabilities component 150 may include extra header fields in a SIP INVITE message that indicate the applications available at the sending participant's endpoint or the capabilities of an endpoint may be sent with each real-time communication.

The computing device on which the system is implemented may include a central processing unit, memory, input devices (e.g., keyboard and pointing devices), output devices (e.g., display devices), and storage devices (e.g., disk drives). The memory and storage devices are computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

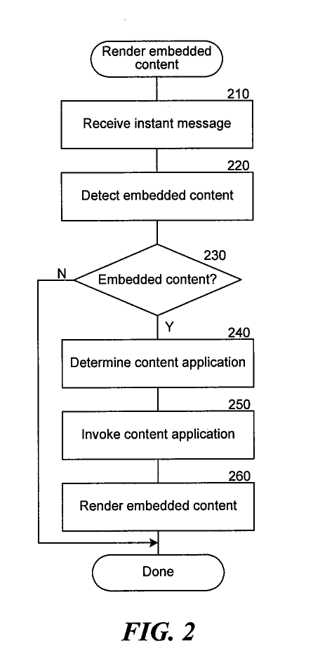

FIG. 2 is a flow diagram that illustrates the processing of the render embedded content component of the system, in one embodiment. The component is invoked when a real-time communication that contains application content is received by a receiving participant's endpoint. In block 210, the component receives an instant message from a receiving participant. In block 220, the component detects whether the instant message contains any embedded application content. In decision block 230, if the instant message contains embedded content, then the component continues at block 240, else the component completes. In block 240, the component determines which application is best suited to render the embedded content. The component may use information embedded within the instant message to determine the best application for rendering the content. In block 250, the component invokes the determined application and passes the application the embedded application content. For example, the application may be an ActiveX control, and the real-time communication software used by the receiving participant may act as an ActiveX container for displaying the ActiveX control. In block 260, the application renders the embedded application content. The application may render the application content directly within a conversation window displayed to the receiving participant, or the application may display a preview of the content in the conversation window with a reference that the receiving participant can select to view the full application content in an external window. After block 260, the component completes.

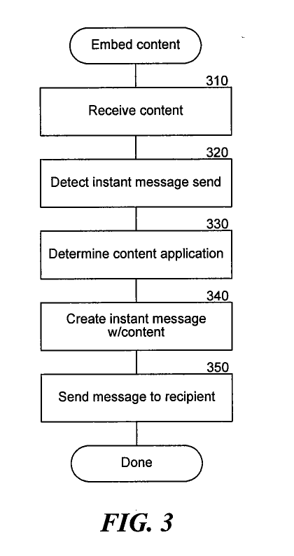

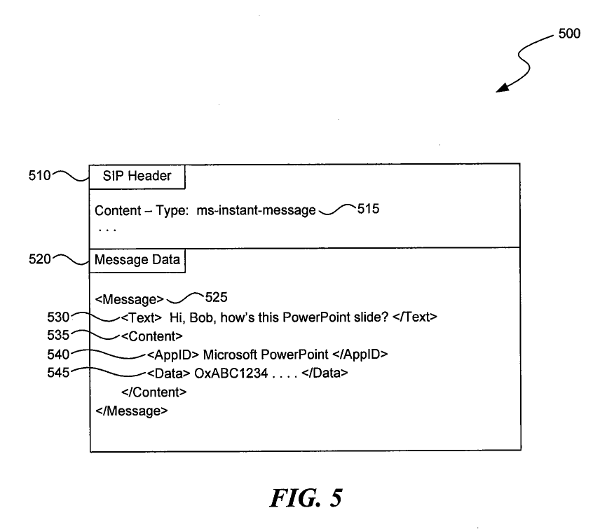

FIG. 3 is a flow diagram that illustrates the processing of the embed content component of the system, in one embodiment. The component is invoked when a sending participant sends an instant message containing application content. In block 310, the component receives application content from the sending participant. For example, the sending participant may paste the application content from an application into a conversation window. In block 320, the component detects that the sending participant wants to send an instant message containing the content. For example, the sending participant may click a send button displayed within the conversation window. In block 330, the component determines the application that created the content. For example, if the sending participant pasted the content from an application to an operating system-provided clipboard, then the clipboard may contain an application identifier identifying the source of the content. In block 340, the component creates an instant message containing the application content. For example, the component may embed the content within an XML message as described below in FIG. 5. In block 350, the component sends the message to the receiving participant. The component then completes.

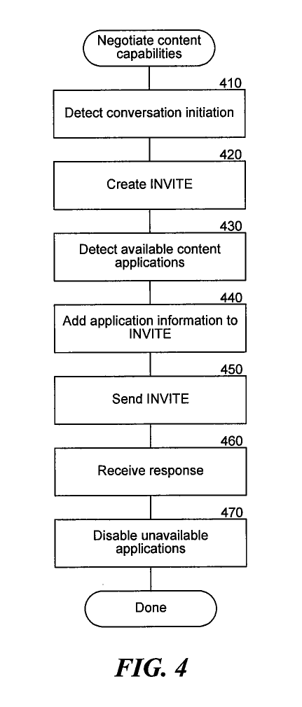

FIG. 4 is a flow diagram that illustrates the processing of the negotiate content capabilities component of the system, in one embodiment. The component is invoked when the endpoints of a sending participant and a receiving participant exchange application content capabilities, such as when an invitation to a conversation is sent. In block 410, the component detects that a conversation between a sending participant and a receiving participant has been initiated. In block 420, the component creates an INVITE message. In block 430, the component detects content applications that are available at the sending participant's endpoint. For example, the sending participant may have a word processing application, spreadsheet application, or other applications installed. In block 440, the component adds the application information to the INVITE message. In block 450, the component sends the INVITE message to the receiving participant's endpoint. In block 460, the component receives a response from the receiving participant's endpoint indicating content applications available at the receiving endpoint. In block 470, the component disables sending content from any applications that the receiving participant does not have installed. For example, the applications may be removed from a list of available content applications in the sending participant's user interface, or a toolbar button for sending content from a particular application may be disabled if the receiving participant does not have that application installed. After step 470, the component completes.

FIG. 5 illustrates a network packet containing an instant message with application content, in one embodiment. The packet 500 contains a SIP header 510 and message data 520. The SIP header 510 contains SIP header fields such as the content type 515 of the message. The message data 520 contains a message XML tag 525 that begins the content of a message. The message XML tag 525 contains a text XML tag 530 and a content XML tag 535. The text XML tag 530 contains text typed by the sending participant. The content XML tag 535 contains application content sent with the message text by the sending participant. The content XML tag 535 contains an AppID XML tag 540 and a data XML tag 545. The AppID XML tag 540 identifies the application for rendering the content. The data XML tag 545 contains binary data that the application can consume. Upon receiving the packet 500, the receiving participant's endpoint can display the text in the text XML tag 530 and invoke the application identified by the AppID XML tag 540 to render the application content contained in the data XML tag 545.

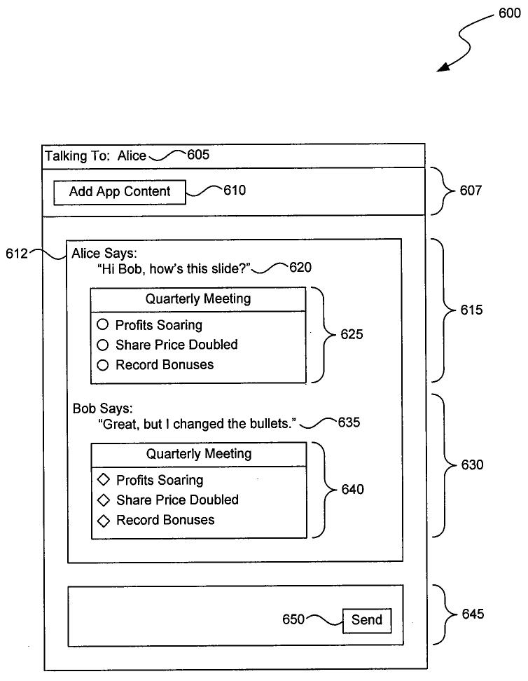

FIG. 6 illustrates a conversation window of the user interface of the real-time communication system, in one embodiment. The conversation window 600 contains a receiving participant identifier 605, a toolbar 607, a conversation history 612, and a message composition area 645. The receiving participant identifier 605 identifies a display name for the receiving participant, Alice. The toolbar 607 contains a button 610 for adding application content to a communication that is part of the conversation. The conversation history 612 contains a running log of the messages sent by each participant. The conversation history 612 contains a message 615 from Alice and a message 630 from Bob. The message 615 from Alice contains a text message 620 and application content 625 that is a slide from a presentation application such as Microsoft PowerPoint. The message 630 from Bob contains a text message 635 and an edited version of the slide 640. As the conversation window shows, Bob and Alice can view and edit application content directly within the conversation window. The message composition area 645 provides an area for a sending participant to enter a new message, and includes a send button 650 for sending the message to the receiving participant.

From the foregoing, it will be appreciated that specific embodiments of the real-time communication system have been described herein for purposes of illustration, but that various modifications may be made without deviating from the spirit and scope of the invention. For example, although conversations have been discussed in terms of a single sending and receiving participant for illustration, conversations may include many participants. Also, although text content has been discussed, real-time conversations may include video, audio, and other types of multimedia in addition to the application content described. Accordingly, the invention is not limited except as by the appended claims.

I/we claim:

1. A method for displaying application content within an instant messaging conversation, the method comprising:
receiving an instant message from a sending participant containing embedded content produced by an application installed on the sending participant's endpoint;
identifying the application that produced the embedded content within the instant message; and
invoking the identified application at the receiving participant's endpoint to render the embedded content within a window displayed at the receiving participant's endpoint.

2. The method of claim 1 further comprising determining if an application is installed at the receiving participant's endpoint that can render the embedded content, and upon determining that no application is installed that can render the embedded content, informing the sending participant.

3. The method of claim 1 further comprising sending an indication of the applications available at the receiving participant's endpoint for rendering embedded content.

4. The method of claim 1 wherein invoking the identified application comprises invoking an ActiveX control.

5. The method of claim 1 wherein invoking the identified application comprises displaying a preview derived from the embedded content within the window.

6. The method of claim 1 wherein receiving an instant message comprises receiving a SIP message structured using XML.

7. The method of claim 1 wherein rendering the embedded content within a window comprises displaying the embedded content within an existing conversation window.

8. The method of claim 1 further comprising archiving the instant messaging conversation including embedded content.

9. The method of claim 1 wherein rendering the embedded content within a window comprises displaying the embedded content within a window other than an existing conversation window.

10. A computer-readable medium encoded with instructions for controlling a computing device to include application content within a real-time communication, by a method comprising:
receiving application content specified by a user, the application content being created by an application installed on the user's computing device;
detecting that the user wants to send a real-time communication;
identifying the application that created the application content;
creating a real-time communication including the application content and an identifier of the identified application; and
sending the real-time communication to one or more other users.

11. The computer-readable medium of claim 10 further comprising determining whether the one or more other users that the real-time communication will be sent to can display the application content.

12. The computer-readable medium of claim 10 wherein creating a real-time communication including the application content comprises creating a preview of the application content and including the preview in the real-time communication.

13. The computer-readable medium of claim 10 wherein receiving application content specified by a user comprises receiving application content pasted from an operating system clipboard.

14. The computer-readable medium of claim 10 wherein receiving application content specified by a user comprises receiving application content opened from a file.

15. The computer-readable medium of claim 10 wherein the application invokes a real-time communication client for sending the content after the application content is created.

16. A computer system for exchanging instant messages containing rich application content, comprising:
a send instant message component configured to create an instant message and sending the instant message to a receiving participant;
an embed content component configured to embed rich application content within an instant message created by the send instant message component;
a receive instant message component configured to receive instant messages over a network; and
a render embedded content component configured to identify rich application content within an instant message and display the rich application content to the receiving participant.

17. The system of claim 16 further comprising a negotiate content capabilities component configured to determine one or more types of content that the render embedded content component can render.

18. The system of claim 17 wherein the negotiate content capabilities component identifies applications installed on a sending participant's computing device and sends an indication of the identified applications to the receiving participant at the initiation of a conversation.

19. The system of claim 16 wherein the embed content component converts the rich application into a common format that the render embedded content component can render.

20. The system of claim 16 wherein the render embedded content component supports editing the embedded content and replying to an instant message with a revised version of the embedded content.
